(19) United States
(12) Patent Application Publication
(10) Pub. No.: US 2026/0093338 A1
(43) Pub. Date: Apr. 2, 2026

(54) GESTURE DETECTION USING CONTINUOUS WAVE FREQUENCY MODULATION

(71) Applicant: Apple Inc., Cupertino, CA (US)

(72) Inventors: Nurul Islam, Cupertino, CA (US); Warren J. Seto, Sunnyvale, CA (US); Ryan J. Dunn, Santa Cruz, CA (US); Jack E. Graves, Sunnyvale, CA (US); Dan Nussinson, Haifa (IL)

(21) Appl. No.: 19/334,728

(22) Filed: Sep. 19, 2025

Related U.S. Application Data
(60) Provisional application No. 63/700,543, filed on Sep. 27, 2024.

(51) Int. Cl. G06F 3/01; G01S 17/32

(52) U.S. Cl. CPC G06F 3/017; G01S 17/32

(57) ABSTRACT

Systems, apparatuses, and methods for gesture detection using continuous wave frequency modulation (FMCW) are described. A method of gesture detection at a wearable device includes emitting, while the wearable device is in contact with skin surface of the wearable device's user, input light modulated according to FMCW, then collecting return light while the wearable device is in contact with the skin surface. The method also includes obtaining an FMCW interference signal based on the return light and reference light, the reference light modulated according to the FMCW. The method then performs determining a rate of phase change signal from the FMCW interference signal, and detecting, from the rate of phase change signal, a gesture performed by the user. The wearable device that performs gesture detection may include an optical sensing assembly with an FMCW sensor, a strap holding the sensor against a user's skin surface, and a processor.

### CROSS-REFERENCE TO RELATED APPLICATIONS

This application claims the benefit under 35 U.S.C. § 119(e) of U.S. Provisional Ser. No. 63/700,543 , filed Sep. 27, 2024, the disclosure of which is hereby incorporated herein by reference in its entirety.

### TECHNICAL FIELD

The described embodiments relate generally to wearable devices and, more particularly, to systems, apparatuses, and methods for gesture detection using continuous wave frequency modulation.

### BACKGROUND

Modern consumer electronic devices take many shapes and forms and have numerous uses and functions. Wearable devices, such as smart watches or augmented reality devices, continue to increase in popularity. These wearable devices are often controlled via one or more input devices, for example a user's manipulation of a button or crown, touch input to a touch surface, or using voice commands to a microphone. In some examples, different interaction types with an input device may result in different responses by the wearable device. It may not always be convenient or feasible for a user to provide input to the device via these input devices. Accordingly, alternative mechanisms to control the wearable devices may be desired.

### SUMMARY

Described herein are systems and methods for gesture detection using continuous wave frequency modulation (FMCW).

Some aspects of this disclosure are directed to a method of gesture detection at a wearable device. The method includes emitting, while the wearable device is in contact with a skin surface of a user of the wearable device, input light that is modulated according to a continuous wave frequency modulation. The method further includes collecting return light while the wearable device is in contact with the skin surface. The method further includes obtaining a FMCW interference signal based at least in part on the return light and reference light, the reference light modulated according to the continuous wave frequency modulation. The method further includes determining a rate of phase change signal from the FMCW interference signal. The method further includes detecting, from the rate of phase change signal, a gesture performed by the user.

Some aspects of this disclosure are directed to a wearable device that includes an optical sensing assembly, a strap, and one or more processors. The optical sensing assembly includes an FMCW sensor, and is configured to generate reference light that is modulated according to a continuous wave frequency modulation, emit input light that is modulated according to the continuous wave frequency modulation, and collect return light. The strap is configured to, while emitting the input light and collecting the return light, maintain the FMCW sensor in contact with a skin surface of a user of the wearable device. The one or more processors are configured to obtain an FMCW interference signal based at least in part on the return light and the reference light, determine a rate of phase change signal from the FMCW interference signal, and detect, from the rate of phase change signal, a gesture performed by the user.

Some aspects of this disclosure are directed to a method of gesture detection at a wearable device. The method includes obtaining, at a wearable device, a frequency modulation continuous wave (FMCW) interference signal that is based at least in part on return light collected while the wearable device is in contact with a wrist of a user. The method further includes detecting, based at least in part on the FMCW interference signal, a gesture performed by the user.

In addition to the exemplary aspects and embodiments described above, further aspects and embodiments will become apparent by reference to the drawings and by study of the following description.

### BRIEF DESCRIPTION OF THE DRAWINGS

To easily identify the discussion of any particular element or act, the most significant digit or digits in a reference number refer to the figure number in which that element is first introduced.

FIG. 1A shows a front view of an example wearable device that can be used to perform gesture detection using continuous wave frequency modulation (FMCW), as described herein.

FIG. 1B shows a back view of an example wearable device that can be used to perform gesture detection using FMCW light, as described herein.

FIG. 1C shows a block diagram of an example wearable device that can be used to perform gesture detection using FMCW light, as described herein.

FIG. 2 shows a cross-sectional view of an example wearable device that can be used to perform gesture detection using FMCW light, as described herein.

FIG. 3A shows an example FMCW sensor that can be used to perform gesture detection using FMCW light, as described herein.

FIG. 3B shows example FMCW waveforms for input light and return light used to perform gesture detection for the example FMCW sensor of FIG. 3A, as described herein.

FIG. 4 shows a process flow diagram that can be used to perform gesture detection using FMCW light, as described herein.

FIG. 5 shows example signal waveforms generated in connection with performing gesture detection using FMCW light, as described herein.

FIG. 6A shows an example signal waveform generated in connection with performing gesture detection using FMCW light, as described herein.

FIG. 6B shows an example signal waveform generated in connection with performing gesture detection using FMCW light, as described herein.

FIG. 7 shows an example method of gesture detection, as described herein.

FIG. 8 shows another example method of gesture detection, as described herein.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

It may not always be convenient or feasible for a user to provide input to a wearable device via existing mechanisms, such as manipulating a button or crown, providing input to a touch surface, or using voice commands. As such, alternative mechanisms to control the wearable devices are desired. A wearable device may be secured to the wrist (e.g., wrist joint or lower forearm) of a user by a band, which may be used to hold an optical sensing assembly against the skin of a user and, in particular, the skin surface. The user typically operates the wearable device through finger contact to a touch-sensitive display on a front of the wearable device, manipulation of one or more buttons or crowns of the wearable device, or via voice or other audio input to a microphone of the wearable device. However, it may be desirable to operate the wearable device via other mechanisms, for example based on the movement of the fingers and/or hand of the same arm where the wearable device is secured to the wrist. For example, fingers of the opposite hand are typically used to provide inputs to the touch-sensitive display or manipulate the crown and/or buttons of the wearable device, effectively requiring use of both hands of the user to provide the inputs. Providing inputs via the same hand to which the wearable device is secured can allow the user to interact with the wearable device even if an opposite hand is unavailable.

Frequency modulation continuous wave (FMCW) sensing is a technique that is typically used to determine range (distance) and velocity information by transmitting laser light in free space to a target. At a high level, FMCW sensing works by transmitting a series of “chirps,” where each chirp includes a light signal modulated in frequency over time during a period. Typically, a chirp is performed during which constant power (amplitude of the light signal) is maintained, while the frequency of the light is modulated. The chirps are often performed as part of a sawtooth pattern or a triangle pattern. In a sawtooth pattern, each chirp ramps frequency in a common direction, such that all of the chirps are associated with a positive rate of change in the frequency (referred to herein as “up-chirps”) or all of the chirps are associated with a negative rate of change in the frequency (referred to herein as “down-chirps”. In a triangle pattern, the rate of change in frequency changes direction between successive chirps, such that pattern alternates between performing an up-chirp and performing a down-chirp.

Range and velocity may be determined by interfering a signal emitted and returned to the FMCW sensor (e.g., after reflection off of a target) with a reference signal (e.g., an untransmitted portion of the emitted signal) as part of one or more chirps. Processing of the interfered signal results in beat note terms, as well as primary and secondary phase terms. When tracking a target that is spaced from the FMCW sensor and/or device containing the FMCW sensor, the beat note signal may be used to determine the range and velocity information, and the primary and secondary phase terms ignored, for example as providing information that is small relative to the range and velocity terms that are of interest, or otherwise inapplicable to the application. However, as further described herein, information derived from the phase terms may be leveraged to detect gestures at a wearable device using FMCW.

Wearable devices are described herein that contain FMCW sensing devices that are configured to introduce light into and collect light from a skin surface of a user. Specifically, the FMCW sensing devices may be oriented to emit and collect light from a side of the wearable device that faces the user's skin surface (e.g., the wrist) when worn by the user. The various concepts described herein are discussed in the context of performing measurements at a user's wrist in order to detect gestures performed by a user's hand (e.g., the hand that corresponds to the wrist being measured), it should be appreciated that these concepts may applied to the detection of gestures at other body locations of a user and/or using measuring light at different skin surfaces of the user.

When performing a measurement, a portion of the FMCW light (input light) generated by a laser of the FMCW sensing device is emitted into the wrist of the user. Return light is then collected and interfered with a second portion of the light (reference light) and an FMCW interference signal is generated. Phase information from the phase terms of the FMCW interference signal is then generated and analyzed, as further described. Specifically, a rate of phase change signal may generate, representing how the instantaneous rate of change of the phase of the FMCW interference signal varies over time. To generate the rate of phase change signal, the FMCW interference signal may be collected over a measurement window. The measurement window may be divided into a plurality of measurement segments, and a rate of phase change may be selected for each measurement segment to form the rate of phase change signal. The rate of phase change signal may be further processed (e.g., using one or more filters) to facilitate analysis of the rate of phase change signal. Depending on certain characteristics of the rate of phase change signal, different gestures performed by a user may be detected. For example, a gesture corresponding to a single tap, a double tap, a tap and hold, or the like may be detected by analyzing a waveform of the rate of phase change signal.

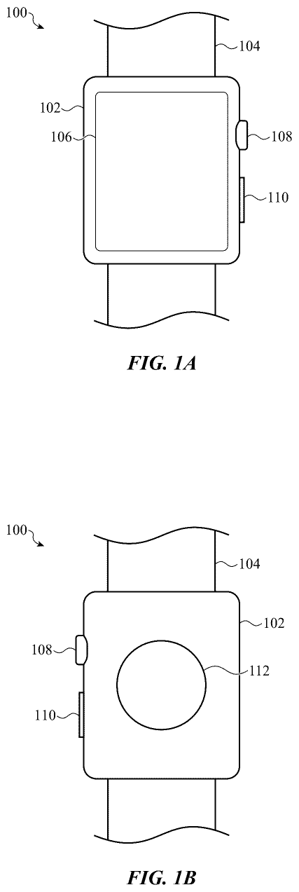

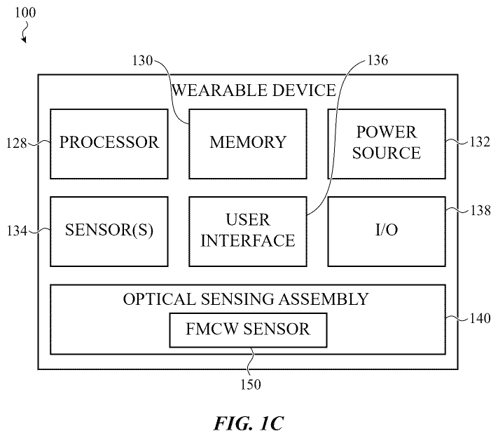

These and other embodiments are discussed below with reference to FIGS. 1A-8. However, those skilled in the art will readily appreciate that the detailed description given herein with respect to these figures is for explanatory purposes only and should not be construed as limiting.

FIG. 1A shows a front view of an example wearable device 100 that can be used to perform gesture detection using FMCW light, as described herein. As shown in FIGS. 1A and 1C, the wearable device 100 is configured as a smartwatch. However, the wearable device 100 configured as a smartwatch is merely one example embodiment of a wearable device, and the concepts discussed herein may apply equally or by analogy to other wearable devices, including smart bands, head-mounted displays, headphones, or the like.

The wearable device 100 may be worn on an arm (e.g., at the user's wrist or forearm) of a user, who may perform gestures using the hand of that arm. The systems and methods described herein may be used to detect one or more gestures (collectively referred to herein as a set of “candidate gestures”) performed by the user. The set candidate gestures may involve particular hand motions, or may involve interaction between a user's hand and an object (e.g., tapping a digit on a surface of an object). For the purpose of illustration, the set of candidate gestures is described herein as including one or more “finger tap” gestures, which involve a user tapping two digits together. While a range of finger tap gestures are described herein as candidate gestures, it should be appreciated that the systems and methods described herein may be configured to detect some or all of these gestures and/or may be configured to detect additional gestures.

A “single tap” gesture refers to a finger tap gesture that involves a user making contact between two digits of the hand, then breaking contact. In some examples, the two digits may be a thumb and first finger (forefinger), thumb and second finger (middle finger), and so on. In some examples, the detection of the single tap may be based on the detection of the breaking contact within a time duration threshold of the making contact. In other examples, such as when the wearable device may detect both a single tap or a tap and hold, detection of the break of contact within the time duration threshold of making contact may indicate a single tap, whereas a failure to detect the break of contact within the time duration threshold may indicate a tap and hold.

A “double tap” gesture refers a finger tap gesture in which a user performs two single taps in succession. In particular, a double tap gestures involves a user making contact between two digits of the hand, breaking contact, again making contact between two digits of the hand, and again breaking contact, all within a certain time threshold of the first contact. In some examples, the two digits may be a thumb and first finger (forefinger), thumb and second finger (middle finger), and so on. The two digits may be the same two digits for the first single tap and the second single tap, or a pair of digits for the first single tap that is different from the pair of digits for the second single tap. If desired, similar principles may be applied to finger tap gestures that require a user to perform three or more taps in succession (e.g., a triple tap gesture, a quadruple tap gesture, or the like).

A “tap and hold” gesture refers a finger tap gesture that involves making contact between two digits of the hand, then maintaining contact (e.g., for at least a certain time duration) before subsequently breaking contact. In some examples, the two digits may be a thumb and first finger (forefinger), thumb and second finger (middle finger), and so on. In some examples, the wearable device 100 registers the tap and hold as soon as the user has held the digits in contact for a threshold time duration (e.g., regardless of whether or when breaking contact is detected). In other examples, the wearable device 100 may register the tap and hold as soon as the user has held for the threshold time duration, and registers an end to the tap and hold when the user breaks (e.g., when breaking contact is detected), for example in an application where detecting making contact in the tap and hold gesture may be used to control the start of a task, and detecting breaking contact may be used to control the end of a task. In yet other examples, the wearable device 100 registers (e.g., considers to be detected) the tap and hold gesture based on detecting the breaking contact (e.g., not upon detecting the making contact). Detection based on breaking contact may provide a variant of the single tap gesture, for example where the user holds the single tap at least a time duration longer than the single tap (e.g., to specify a different action from an action specified by the single tap).

A “tap and ramp” refers to a figure tap gesture that involves making contact between two digits of the hand, then maintaining contact while increasing the pressure between the two digits (e.g., for at least a certain time duration) before subsequently breaking contact. In some examples, the two digits may be a thumb and first finger (forefinger), thumb and second finger (middle finger), and so on. The tap and ramp gesture may be an example of a tap and hold gesture during which the user changes the level of pressure between the digits. In some examples, depending on the operation controlled by this gesture, the wearable device 100 may perform an action in response to detecting the tap and ramp. In some instances the nature of the action performed in response to detecting the tap and ramp may depend on one or more characteristics of the pressure change. For example, an increasing pressure change may be used to increase the volume of an audio output (e.g., as generated by the wearable device 100), and the amount of volume increase may depend on the amount of pressure applied and/or the duration over which the user increases pressure during the tap and ramp gesture.

A “tap and slide” refers to refers to a finger tap gesture that involves making contact between two digits of the hand, then rubbing the two digits against each other while maintaining contact (e.g., for at least a certain time duration). In some examples, the two digits may be a thumb and first finger (forefinger), thumb and second finger (middle finger), and so on. The tap and slide gesture may be an example of a tap and hold gesture during which the user changes a position of the digits relative to each other. In some examples, depending on the operation controlled by this gesture, the wearable device 100 may perform an action in response to detecting the tap and slide. In some instances the nature of the action performed in response to detecting the tap and slide may depend on one or more characteristics of the movement of the digits relative to each other. For example, movement of a first digit relative to a second digit may be used to increase the volume of an audio output (e.g., as generated by the wearable device 100), and the amount of volume increase may depend on the amount of movement and/or the duration over which the user slides a digit during the tap and slide gesture.

The wearable device 100 includes a housing 102 and a band 104 coupled to the housing. The housing 102 may at least partially define an internal volume in which components of the wearable device 100 may be positioned. The housing 102 may also define one or more exterior surfaces of the device, such as all or a portion of one or more side surfaces, a rear surface, a front surface, and the like. The band 104 may be formed of any suitable material, such as metal (e.g., aluminum, steel, titanium, or the like), ceramic, polymer, glass, or the like.

The band 104 may attach the wearable device 100 to a user, such as to the user's arm or wrist. The wearable device 100 may include battery charging components within the wearable device 100, which may receive power, charge a battery of the wearable device 100, and/or provide direct power to operate the wearable device 100 regardless of the battery's state of charge (e.g., bypassing the battery of the wearable device 100). In some cases, the battery charging components may include a coil such that the smartwatch my receive power wirelessly (e.g., via inductive power transfer). The wearable device 100 may include a magnet, such as a permanent magnet, that magnetically couples to a magnet (e.g., a permanent magnet, electromagnet) or magnetic material (e.g., a ferromagnetic material such as iron, steel, or the like) in a charging dock (e.g., to facilitate wireless charging of the wearable device 100) or other accessory device described herein.

The wearable device 100 can include a display 106. The display 106 can be positioned at least partially within the housing 102. The display 106 may define an output region in which graphical outputs are displayed. Graphical outputs may include graphical user interfaces, user interface elements (e.g., buttons, sliders, etc.), text, lists, photographs, videos, or the like. In some cases, the display 106 may output a graphical user interface with one or more graphical objects that display information for one or more applications with which the user may interact using one or more gestures. For example, the display 106 may provide a display that may update responsive to gestures performed by a user and sensed by the wearable device 100.

The display 106 may include a display which may be implemented as a liquid-crystal display (LCD), organic light-emitting diode (OLED) display, light-emitting diode (LED) display, or the like. If the display is an LCD, the display may also include a backlight component that can be controlled to provide variable levels of display brightness. If the display is an OLED or LED type display, the brightness of the display 106 may be controlled by modifying the electrical signals that are provided to display elements. The display 106 may correspond to any of the displays shown or described herein.

The display 106 may include or be associated with touch sensors and/or force sensors that extend along the output region of the display and which may use any suitable sensing elements and/or sensing techniques. Using touch sensors, the wearable device 100 may detect touch inputs applied to the cover, including detecting locations of touch inputs, motions of touch inputs (e.g., the speed, direction, or other parameters a gesture applied to the cover can generate), or the like. Using force sensors, the wearable device 100 may detect amounts or magnitudes of force associated with touch events applied to the cover. The touch and/or force sensors may detect various types of user inputs to control or modify the operation of the wearable device 100, including taps, swipes, multiple finger inputs, single-or multiple-finger touch gestures, presses, and the like.

The wearable device 100 may also include one or more user input devices such as a first input device 108 having a cap, crown, protruding portion, or component(s) or feature(s) positioned along a side surface of the housing 102. At least a portion of the first input device 108 (such as a crown body) may protrude from, or otherwise be located outside, the housing 102, and may define a generally circular shape or circular exterior surface. The exterior surface of the first input device 108 may be textured, knurled, grooved, or otherwise have features that may improve the tactile feel of the first input device 108 and/or facilitate rotation sensing.

The first input device 108 may facilitate a variety of potential interactions. For example, the first input device 108 may be rotated by a user (e.g., the crown may receive rotational inputs). Rotational inputs of the first input device 108 may zoom, scroll, rotate, or otherwise manipulate a user interface or other object displayed on the display 106 among other possible functions. The first input device 108 may also be translated or pressed (e.g., axially) by the user. Translational or axial inputs may select highlighted objects or icons, cause a user interface to return to a previous menu or display, or activate or deactivate functions among other possible functions.

In some cases, the wearable device 100 may sense touch inputs applied to the first input device 108, such as a finger sliding along the body of the first input device 108 (which may occur when first input device 108 is configured to not rotate) or a finger touching the body of the first input device 108. In such cases, sliding gestures may cause operations similar to the rotational inputs, and touches on a cap or crown may cause operations similar to the translational inputs. As used herein, rotational inputs include both rotational movements of the first input device 108, as well as sliding inputs that are produced when a user slides a finger or object along the surface of a crown in a manner that resembles a rotation (e.g., where the crown is fixed and/or does not freely rotate).

The wearable device 100 may also include other input devices, switches, buttons, or the like. For example, the wearable device 100 includes a second input device 110, which may be a button. The second input device 110 may be a movable button or a touch-sensitive region of the housing 102. The button may control various aspects of the wearable device 100. For example, the button may be used to select icons, items, or other objects displayed on the display 106, to activate or deactivate functions (e.g., to silence an alarm or alert), or the like.

FIG. 1B shows a back view of the example wearable device 100. The wearable device 100 may include one or more windows 112 (one of which is shown) that allow light to pass through a portion of the housing 102. The one or more windows 112 may be part of an optical sensing system and coupled to the housing 102. The one or more windows 112 may include light transmissive materials and be associated with internal sensor components, which may be used to determine biometric information of a user, such as heart rate, blood oxygen concentrations, and the like, as well as allow the transmission and reception of FMCW signals from an FMCW sensor used for gesture detection. The particular arrangement of the one or more window(s) 112 in the housing 102 shown in FIG. 1B is one example arrangement, and other window arrangements (including different numbers, sizes, shapes, and/or positions of the windows) are also contemplated. As described herein, the window arrangement may be defined by or otherwise correspond to the arrangement of components in the integrated sensor package.

FIG. 1C shows a block diagram of an example wearable device that can be used to perform gesture detection using FMCW light, as described herein. The wearable device 100 includes an FMCW sensor 150, which can be an example of the FMCW devices described herein, and can be used to perform gesture detection as described herein.

The smartwatch 120 can include a processor 128, memory 130, a power source 132, one or more sensors 134, a user interface 136, an input/output (I/O) mechanism 138, and an optical sensing assembly 140. The wearable device 100 (e.g., a smartwatch) can be an example of a wearable device described herein (e.g., wearable device 100 and include components described with respect to the wearable device 100).

The processor 128 can control some or all of the operations of the wearable device 100. The processor 128 can communicate, either directly or indirectly, with some or all of the components of the wearable device. For example, a system bus or other communication mechanism can provide communication between, the processor 128, the memory 130, the power source 132, the one or more sensors 134, the user interface 136, the I/O mechanism 138, and the optical sensing assembly 140.

The processor 128 can be implemented as any electronic device capable of processing, receiving, or transmitting data or instructions. For example, the processor 128 can be a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitable computing element or elements.

It should be noted that the components of the wearable device 100 can be controlled by multiple processors. For example, select components of the wearable device 100 (e.g., a sensor 134) may be controlled by a first processor and other components of the wearable device 100 (e.g., the I/O mechanism 138) may be controlled by a second processor, where the first and second processors may or may not be in communication with each other.

The memory 130 can store electronic data that can be used by the electronic device. For example, the memory 130 can store electrical data or content such as, for example, measured electrical signals, audio and video files, documents and applications, device settings and user preferences, timing signals, control signals, and data structures or databases. The memory 130 can be configured as any type of memory. By way of example only, the memory 130 can be implemented as random access memory, read-only memory, Flash memory, removable memory, other types of memory storage elements, or combinations of such devices.

The power source 132 can be implemented with any device capable of providing energy to the wearable device 100. For example, the power source 132 may be one or more batteries or rechargeable batteries.

The wearable device 100 may also include one or more sensors 134 in addition to the optical sensing assembly which may provide additional functionality to the wearable device 100. The sensor(s) 134 can be configured to sense one or more type of parameters, such as but not limited to, electrical signals, pressure, sound, light, touch, heat, movement, relative motion, biometric data (e.g., physiological parameters), and so on. For example, the sensor(s) 134 may include one or more electrodes (and corresponding circuitry), a pressure sensor, an auditory sensor, a heat sensor, a position sensor, a light or optical sensor, an accelerometer, a pressure transducer, a gyroscope, a magnetometer, a health monitoring sensor, and so on. Additionally, the one or more sensors 134 can utilize any suitable sensing technology, including, but not limited to, capacitive, ultrasonic, resistive, optical, ultrasound, piezoelectric, and thermal sensing technology. When used in connection with the FMCW sensor 150, for example to detect gestures or confirm the detection of gestures, the one or more sensors 134 may be referred to as additional sensors. For example, the one or more sensors 134 may include an inertial measurement unit (IMU), which may be configured to measure movement and/or detect the orientation of the wearable device 100. The IMU may include one or more sensors, such as one or more accelerometers, one or more gyroscopes, and/or one or more magnetometers, and may utilize signals generated from these sensors to generate motion information and/or orientation information of the wearable device 100. Information from the IMU may be used, in conjunction with information from the FMCW sensor 150, to identify that a user has performed a particular candidate gesture.

The wearable device 100 may also include a user interface 136, which may be an example of the display 106. The user interface 136 may include a display which may be implemented as a liquid-crystal display (LCD), organic light-emitting diode (OLED) display, light-emitting diode (LED) display, or the like. If the display is an LCD, the display may also include a backlight component that can be controlled to provide variable levels of display brightness. If the display is an OLED or LED type display, the brightness of the user interface 136 may be controlled by modifying the electrical signals that are provided to display elements. The user interface 136 may correspond to any of the displays shown or described herein.

An I/O mechanism 138 can transmit and/or receive data from a user or another electronic device. The I/O mechanism 138 can include a display, a touch sensing input surface, one or more buttons (e.g., a graphical user interface “home” button), one or more cameras, one or more microphones or speakers, one or more ports, such as a microphone port, and/or a keyboard. Additionally or alternatively, an I/O mechanism 138 or port can transmit electronic signals via a communications network, such as a wireless and/or wired network connection. Examples of wireless and wired network connections include, but are not limited to, near field communication (NFC), radio frequency (RF), cellular, Wi-Fi, Bluetooth, infrared (IR), or Ethernet connections.

The optical sensing assembly 140 may include a cover that defines an exterior surface of the wearable device 100, one or more light emitters configured to emit light through the cover. Each light emitter can emit light at a corresponding wavelength. The optical sensing assembly 140 may include multiple light emitters that emit light at a particular wavelength and/or may include multiple light emitters that each emit light at a different corresponding wavelength. In some cases, one or more light emitters may be configured to emit light within a particular range, which may include wavelengths in the visible or infrared ranges. For example, emitted wavelengths may include: wavelength ranging from 620 nm to 1 mm; wavelengths in the green wavelength range, which may include wavelengths ranging from 495 nm to 570 nm; and/or in any other visible and/or near-visible wavelength ranges. Certain light emitters may emit multiple different wavelengths (or wavelength ranges) simultaneously or may be tunable to vary the emitted wavelength. In some examples, for example in a gesture detection configuration or during a gesture detection mode, the light emitters may be modulated according to continuous wave frequency modulation, and emit FMCW light. In some examples, one or more light emitters emitting FMCW light may be a laser.

The optical sensing assembly 140 may further include one or more photodetectors configured to receive light through the cover. The photodetectors can be configured to measure light intensity of light emitted by one or more light emitters.

The optical sensing assembly 140 may further include an FMCW sensor 150 as further described herein. The FMCW sensor 150 may be configured to collect or otherwise receive or detect laser light modulated according to a continuous wave frequency modulation, as further described herein. In some examples, one or more of the photodetectors of the optical sensing assembly 140 may be configured to operate as part of the FMCW sensor 150. The FMCW sensor 150 may receive light (e.g., return light that is FMCW modulated) through the cover, for example through a window (e.g., a transparent window) of the cover of the optical sensing assembly 240. In some examples, the FMCW sensor 150 may be associated with a transparent window different from a transparent window from which the FMCW light is emitted. In other examples, the FMCW sensor 150 may use a common window to both emit and collect the FMCW light.

In some cases, the optical sensing assembly 140 may include more than one of the FMCW sensor 150, for example on opposite sides of the optical sensing assembly 140 to collect return light from different portions of a wrist or arm.

In some cases, the optical components can include films or other surface features that are applied to the transparent cover (and transparent windows of the transparent cover) and may be position on an internal surface of the cover, an external surface of the cover, or within a thickness of the cover. The films or other surface features can be configured to block, filter, focus or otherwise modify light emitted from and/or received by the optical sensing assembly 140.

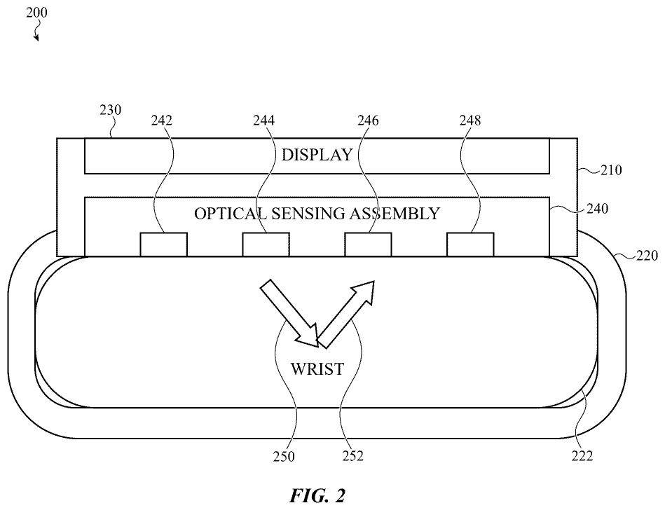

FIG. 2 shows a cross-sectional view of an example wearable device 200 that can be used to perform gesture detection using FMCW light, as described herein. Wearable device 200 includes a housing 210 and a band 220. The housing 210 supports a display 230 and an optical sensing assembly 240. The display 230 may be on a front surface of the housing 210, and thus the front side or face of the wearable device 200, and the optical sensing assembly 240 on a back surface of the housing 210, and thus the back side or face of the wearable device 200, generally facing a user's wrist 222. The housing may enclose or otherwise support additional components of the wearable device 200 that are not shown, for example, various components of wearable device 200 described herein.

The optical sensing assembly 240 may include a set of transparent windows, such as a transparent window 242, a transparent window 244, a transparent window 246, and a transparent window 248. One or more of the set of transparent windows may be used to facilitate or otherwise allow the emission of input light 250 through the transparent window. One or more of the set of transparent windows may also be used to facilitate or otherwise allow the collection of return light 252 through the transparent window. In some examples, for FMCW light used for gesture detection, input light 250 is emitted and return light 252 is collected via a same transparent window. In other examples, the input light 250 is emitted via a first transparent window (e.g., transparent window 244) and return light 252 is collected via a second transparent window (e.g., transparent window 246).

The band 220 (e.g., a wrist band or arm band, or other strap) may be attached to the housing 210 and configured to secure the wearable device 200 relative to a wrist 222 of a user (e.g., wearer) of the wearable device 200. When fastened about the wrist 222, the band 220 is positioned and configured to secure the set of transparent windows of the optical sensing assembly 240 against the skin surface of the user. Although referred to as a wrist 222, it should be noted that the wrist 222 is not limited to a user's wrist joint. That is, it is contemplated that the wrist 222 generally may include an area of the forearm or lower arm closer to a user's wrist joint and hand than to a user's elbow. More generally, gesture detection using the techniques described herein may be accomplished where the wearable device 200 is secured against the user's arm, including a forearm, and the optical sensing assembly positioned against the skin surface of the user to detect gestures performed using the hand of the user.

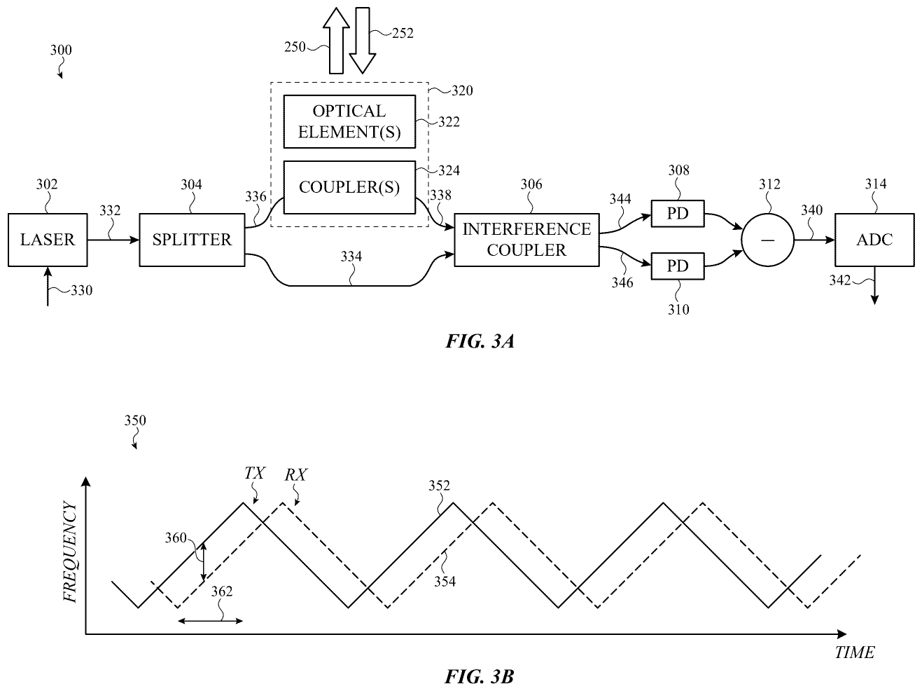

FIG. 3A shows an example FMCW sensor 300 that can be used to perform gesture detection using FMCW light, as described herein. The FMCW sensor 300 may be an example of the FMCW sensor 150. FMCW sensor 300 is an example of a sensor that utilizes a photonic circuit to route light within the FMCW sensor 300. It should be appreciated, however, that any suitable arrangement of components may be used to perform the functions of the FMCW sensor (e.g., to generate input light and reference light, emit the input light from the FMCW sensor 300, collect return light, and interfere the return light with the reference light to generate a FMCW interference signal).

The FMCW sensor 300 includes a laser 302, an optical splitter 304, optical I/O elements 320, an interference coupler 306, a first photodiode 308, a second photodiode 310, a subtractor 312, and an analog to digital converter (ADC) 314.

The laser 302 may be any suitable laser technology capable of being controlled (e.g., via a control signal 330) to vary the output frequency of emitted laser light according to FMCW. The laser 302 may include a semiconductor laser, such as a laser diode (e.g., a distributed Bragg reflector laser, a distributed feedback laser, an external cavity laser), a quantum cascade laser, or the like. In some examples, the laser 302 may be a vertical cavity surface emitting laser (VCSEL). The laser 302 may be stimulated to emit laser light (e.g., via the control signal 330). As described herein, including with reference to FIG. 3B, to facilitate gesture detection, the laser 302 may be modulated according to a continuous wave frequency modulation to generate FMCW light 332.

The FMCW light 332 may be provided to the photonic circuit and split using the optical splitter 304 (e.g., a directional coupler, a y-junction splitter, a multimode interference splitter, or the like). The outputs of the optical splitter 304 include an input light 336 to be emitted from the FMCW sensor 300, and reference light 334. The ratio of light splitting into the input light 336 and the reference light 334 may subject to a particular configuration (e.g., it may be desirable to have a splitting ratio that prioritizes the input light 336). The input light is directed to the optical I/O elements 320 to be emitted toward the wrist of a user via one or more transparent windows of the optical sensing assembly. The reference light 334 is directed by the photonic circuit to the interference coupler 306 (e.g., a Mach-Zehnder interferometer, a multimode interferometer, or the like), where it will be optically interfered with return light that is collected via one or more transparent windows of the optical sensing assembly.

The optical I/O elements 320 may be configured to couple input light 336 out of the photonic circuit (and ultimately out of the FMCW sensor 300 as input light 250). Similarly, the optical I/O elements 320 may be configured to receive return light 252 that is received by the FMCW sensor 300, and to couple the return light 252 into the photonic circuit as return light 338. Specifically, the optical I/O elements 320 may include one or more coupler(s) 324 (e.g., edge couplers, a vertical output couplers, or the like) that are configured to emit input light 336 from the photonic circuit and to couple the return light 338 into the photonic circuit. In some configurations, the one or more coupler(s) 324 include multiple couplers, such as a first coupler to emit the input light 336 from the photonic circuit as input light 250 and a second coupler to couple the return light 252 into the photonic circuit as return light 338. In some examples, the input light 250 may be emitted through a first transparent window and the return light 252 collected through a second transparent window. In other configurations, the one or more coupler(s) 324 includes a coupler that both emits the input light 336 from the photonic circuit and couples the return light 252 into the photonic circuit. In some of these variations, the input light 250 and the return light 252 may be emitted and collected through a same transparent window.

In some examples, the optical I/O elements 320 includes a set of optical element(s) 322. For example, the optical element(s) 322 may include one or more lenses to direct the input light 250 and/or the return light 252 into or out of the coupler(s) 324. In some examples, the optical element(s) 322 may be one or more transparent windows that provide a window to allow the passage of the input light 250 and/or the return light 252 into or out of the coupler(s) 324 and provide a surface against which the skin surface of a user may be maintained at a separation from the elements of the FMCW sensor 300.

After the return light 252 is coupled into the photonic circuit as return light 338, the return light 338 and the reference light 334 are directed to the interference coupler 306, which allows the interaction and interference of the electromagnetic waves of the return light 338 and the reference light 334. A first optical output 344 of the interference coupler 306 is directed to a first photodiode 308 of a pair of balanced photodiodes. A second optical output 346 of the interference coupler 306 is directed to a second photodiode 310 of the pair of balanced photodiodes. The first optical output 344 has a first intensity and the second optical output 346 has a second intensity, each of which varies as a function of the difference in frequency between the return light 338 and the reference light 334. As such, the relative intensity between the first optical output 344 and the second optical output 346 may be used to characterize the frequency difference even as the intensity of the return light 338 varies relative to the reference light 334. A subtractor 312 provides an analog electrical signal output 340 that corresponds to a difference between the first optical output 344 and the second optical output 346. The analog electrical signal output 340 may vary based on interference of the return light 338 and the reference light 334.

The ADC 314 converts the analog electrical signal output 340 to a digital signal, which is the FMCW interference signal 342. The FMCW interference signal 342 may be processed and analyzed to detect gestures performed by a user of a wearable device that includes the FMCW sensor 300, as further described herein.

FIG. 3B shows a timing diagram 350 of example FMCW waveforms for the input light 250, reference light 334, and return light 252 that are used to generate a FMCW used to perform gesture detection for the example FMCW sensor 300 of FIG. 3A, as described herein.

Specifically, a first waveform 352 shows the frequency modulation that is applied to the input light 250 and reference light 334. According, the first waveform represents the frequency of the transmitted signal TX over time, and thus represents the frequency of the input light 250 and the reference light 334 at any given moment in time. The transmitted signal TX is frequency modulated in a continuous wave pattern. In the variation shown in FIG. 3B, transmitted signal TX may be frequency modulated according to a triangle wave pattern that alternates between up-chirps and down-chirps, though it should be appreciated that any suitable waveform 352 may be used. The first waveform 352 of FIG. 3B that does not have any pause in frequency modulation between chirps, however the first waveform 352 may be configured to include a delay between certain chirps. Additionally, while the first waveform 352 is shown in FIG. 3B as a symmetric triangle wave (e.g., the up-chirps have the same slop as the down-chirps), the waveform 352 may be configures as an asymmetric triangle wave if so desired.

Similarly, a second waveform 354 represents a frequency of the received signal RX (e.g., the return light 252) that is measured at a given time. A time delay is introduced between the transmitted signal TX and the received signal RX that is based on a distance that input light 250 travels from the FMCW sensor 300 before returning as return light 252 at the FMCW sensor 300. The frequency difference 360 between the transmitted signal TX and the received signal RX can provide information about the environment measured by the FMCW sensor 300.

Specifically, the interference between the return light 252 and the reference light 334 generates a beat note that depends on the distance that the input light 250 travels from the FMCW sensor 300 before returning as return light 252, such as described in more detail herein. Typical FMCW sensors assume a minimum spacing from an object being analyzed, and the beat note information may be used to detect a distance to a particular object. The FMCW sensors described herein (e.g., the FMCW sensor 300 of FIG. 3A), however, detect gestures while the user's skin surface is already in contact with the device. In these instances, light will enter the user's skin, react with different tissue structures (e.g., via scattering), and return to the FMCW sensor. Different amounts of light will return from different depths within the user's body (and thus return with different delays) depending on the relative arrangement of tissue structures within the user's body. The relative arrangement of tissue structures within the user's body may change over time, such as a result of user movement. For example, movement of a user's finger relative to their hand and/or movement of their hand relative to their wrist may cause movement of tendons and other tissue structures within a wrist. This tissue movement may change how light is returned to the FMCW sensor.

Due to the heterogenous and complex nature of the tissue of a user's wrist, traditional range estimation techniques may provide limited information when evaluating light that entered and exited through a user's skin. Conversely, by evaluating how the instantaneous rate of phase change of a FMCW interference signal varies over time, the systems and methods described herein may be able to detect one or more gestures performed by a user. Accordingly, gesture detection techniques described herein may obtain rate of phase change signal from a FMCW interference signal as described herein. The rate of phase change signal may be analyzed to detect a gesture performed by the user.

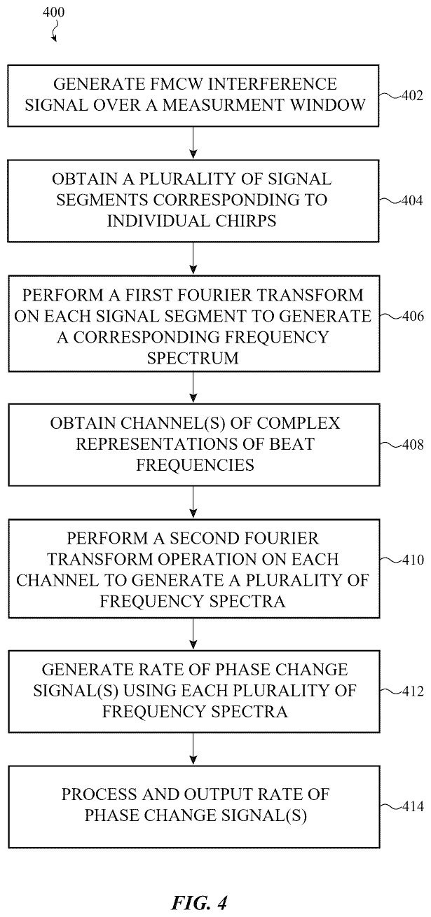

FIG. 4 shows a diagram of a process 400 that may be used to generate a rate of phase change signal from an FMCW interference signal over a measurement window. The measurement window is divided into a plurality of measurement segments, and the rate of phase change signal includes a value of the instantaneous rate of phase change for each measurement segment. Additionally, each measurement segment is associated with a corresponding plurality of chirps. Information derived from individual chirps may be used to calculate the value of the instantaneous rate of phase change for each measurement segment. The process 400 may be continuously performed in a gesture detection mode of a wearable device that is contact with the skin surface of a user. That is, one or more steps in the process 400 may be being performed simultaneously, with information continuously flowing from one step to a subsequent step.

At step 402, the process 400 includes generating a FMCW interference signal over measurement window that includes multiple chirps. Specifically, a FMCW sensor may generate input light and reference light that is modulated according to the continuous wave frequency modulation, collect return light, and obtain an FMCW interference signal based on interference between the return light and the reference light. At step 404, the FMCW interference signal is divided into a plurality of signal segments, each of which corresponds to a different chirp. For example, each signal segment may be selected to be a portion of the FMCW interference signal that represents a predetermined portion of the chirp, such as indicated by line 362 in FIG. 3B. The signal segment may be any percentage of the corresponding chirp duration (e.g., 50% of the chirp, 70% of the chirp, or the like). In variations in which the multiple chirps include up-chirps and down-chirps, the signal segments of the up-chirps and the down-chirps may be separated into different channels. These channels may be processed separately, such that the signal segments associated with the up-chirps are processed separately from the signal segments associated with the down-chirps.

At step 406, a first Fourier transform (e.g., a fast Fourier transform) operation may be performed on each of the signal segments to generate a corresponding frequency spectrum (also referred to herein as a “first frequency spectrum”) for each signal segment. The first frequency spectrum for each measurement spectrum may be analyzed to select a beat frequency for each signal segment. For example, the beat frequency of a signal segment may be selected as the frequency in the corresponding first frequency spectrum having the largest magnitude. Each beat frequency selected in this manner represents the beat frequency of the FMCW interference signal at a given moment of time. Each beat frequency may be represented in its complex representation as a complex number.

Accordingly, the process 400 may, at step 408, obtain one or more channels of complex representations of beat frequencies across the measurement window. For example, when the FMCW interference signal is associated with both up-chirps and down-chirps, the process 400 may obtain a first channel that includes the complex representations of beat frequencies that were selected for the signal segments associated with down-chirps. Similarly, the process 400 may obtain a second channel that includes the complex representations of beat frequencies that were selected for the signal segment associated with up-chirps. In effect, each channel represents how the complex representation of the beat frequency changes over time for that type of chirp.

At step 410, the process 400 may, for each channel, perform a second Fourier transform operation on the complex representations of the beat frequencies to generate a corresponding plurality of frequency spectra (also referred to herein as “second frequency spectra”), where each individual second frequency spectrum corresponds to a different measurement segment of the measurement window. At step 412, the process 400 includes generating, for each channel, a corresponding rate of phase change signal using the corresponding plurality of second frequency spectra. For example, at step 412, the process 400 may generate a first rate of phase change signal for the first channel (e.g., using a plurality of second frequency spectra corresponding to the first channel) and may generate a second rate of phase change signal for the second channel (e.g., using a plurality of second frequency spectra corresponding to the second channel). In these variations, the first rate of phase change signal corresponds to the down-chirps, and the second rate of phase change signal corresponds to the up-chirps.

To generate a rate of phase change signal, the process 400 may include selecting a corresponding target frequency from each of the plurality of second frequency spectra, and thus the rate of phase change signal includes a selected target frequency at each moment in time. Accordingly, a target frequency may be selected for each measurement segment, and may represent the rate of phase change of the FMCW interference signal during that measurement segment. It should be appreciated that the rate of phase change signal may be generated from the plurality of second frequency spectra in any suitable manner (e.g., using one or more non-linear filters or the like).

At step 414, the process includes 400 outputting one or more rate of phase change signal (also referred to as one or more “output rate of phase change signal”) that is generated or selected from the rate of phase change signal(s) generated at step 412. For example, the rate of phase change signal(s) generated at step 412 may undergo additional processing steps. For example, in some variations, one or more filters, such as an infinite impulse response (IIR) filter and/or a bandpass filter (e.g., a having a passband from 70 to 300 Hertz, 10 to 300 Hertz, or the like), may be applied to each rate of phase change signal to generate a filtered rate of phase change signal. In some variations, one or more of the filtered rate of phase change signals may be selected as the output phase change signal(s).

In some variations, where multiple rate of phase change signals are generated at step 412, these signals may be combined into a single output rate of phase change signal. For example, the first and second rate of phase change signals described herein may be correlated and combined (e.g., after each respective rate of phase change signals has been filtered) to generate an output rate of phase change signal. Each output rate of phase change signal outputted by the process 400 may, during a gesture detection mode, be analyzed to identify the occurrence of a particular gesture performed by a user.

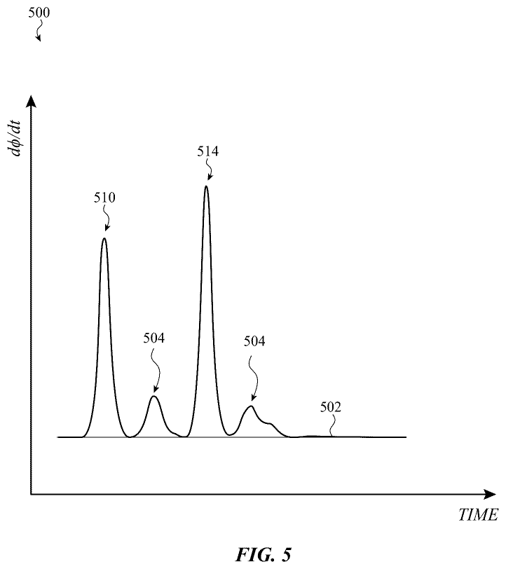

FIG. 5 shows a timing diagram 500 of a signal waveform 502 of a rate of phase change signal, such as may be outputted by the process 400 of FIG. 4. Specifically, the waveform 502 shows an example plot of values for a rate of phase change (dφ/dt) versus time. In this particular example, the waveform 502 shows an example of a waveform resulting from a double tap gesture. The double tap gesture may be characterized by four peaks in the waveform 502, including two relatively larger peaks that result from fingers making contact during the gesture (referred to herein as “make peaks”) and two relatively smaller peaks that result from fingers breaking contact during the gesture (referred to herein as “break peaks”). As shown in the waveform 506, the detection of a first make peak 510 followed by a second make peak 514 may indicate a double tap gesture having been performed by the user. A first break peak 512 and a second break peak 516 may also be used to confirm detection of the double tap gesture in some examples.

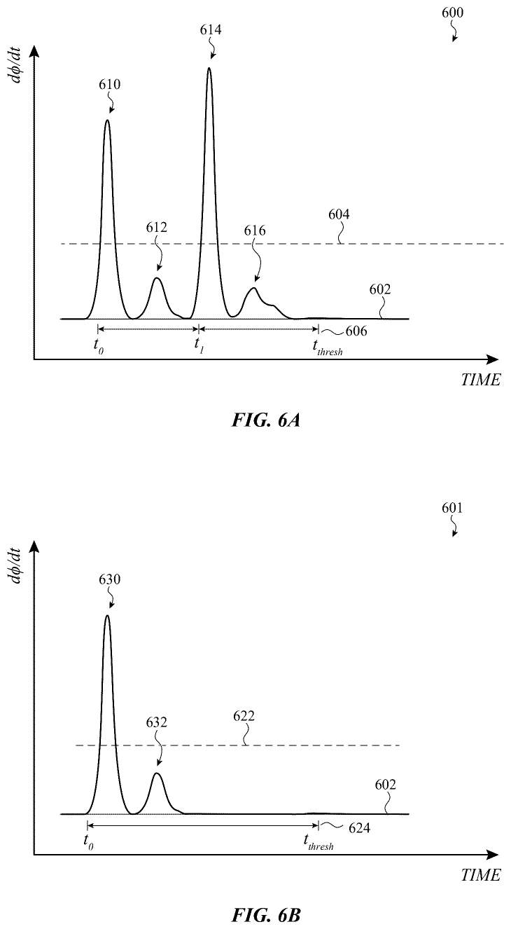

FIG. 6A shows an example timing diagram 600 of a signal waveform 602 of a rate of phase change signal, such as may be outputted by the process 400 of FIG. 4. In particular, signal waveform 602 depicts detection of a double tap gesture using a threshold value 604. A particular tap may be detected when the signal waveform 602 exceeds the threshold value 604, or when the signal waveform 602 exceeds the threshold value 604 and then falls back below the threshold value 604. As shown in the signal waveform 602, there is a first make peak 610 followed by a second make peak 614 that may indicate a double tap gesture having been performed by the user.

A gesture detection process may use a threshold value 604 for the rate of phase change. The threshold value 604 may be set to differentiate between make peaks and break peaks. In some examples, the threshold value may be dynamic. For example, the threshold value 604 may have a first value to detect a first tap. Once the first tap has been detected, and within a time window 606, the threshold value 604 may then have a different value for the detection of a potential second tap of the double tap.

At time t₀, the value of the rate of change exceeds the threshold value 604, which may indicate a detection of the first make peak 610. A time window 606 (tₜₕᵣₑₛₕ) that follows time t₀ may then be used to determine whether a second tap occurs. In some examples, the duration (length) of the time window 606 may be specific to double tap detection. In other examples, the duration of the time window 606 may be associated with all gestures that may be detected.

Next, and during the time window 606, a break peak 612 may occur. However, because the break peak 612 does not exceed the threshold value 604, the break peak 612 does not trigger the detection of a second tap.

However, later during the time window 606, a second make peak 614 occurs. At time t₁, the value of the rate of change exceeds the threshold value 604 for the second make peak 614. Because time t₁ occurs within the time window 606 and the threshold value 604 is exceeded, the gesture detection process determines that a second tap has occurred. As such, a double tap may be detected. In some instances, the detection of a second break peak 616 may be required to confirm the occurrence of a double tap gesture.

FIG. 6B shows another example timing diagram 601 of the signal waveform 602 of the rate of phase change signal, in which a single tap gesture may be detected from the signal waveform 602.

A gesture detection process may use a threshold value 622 to detect the occurrence of a make peak 630 that corresponds to a single tap. The make peak 630 (and thus the single tap) may be detected when the signal waveform 602 exceeds the threshold value 622, or when the signal waveform 602 exceeds the threshold value 622 and then falls back below the threshold value 604. In some variation, the threshold value 622 used to detect a tap as part of a single tap gesture may be different than the threshold value 604 used to detect taps as part of a double tap gesture. In other examples, the threshold value 604 may be the same as the threshold value 622.

As an FMCW sensing device generates an FMCW interference signal, the value of the rate of phase change signal is determined by the wearable device. At time t₀, the value of the rate of change exceeds the threshold value 622. A time window 624 (tₜₕᵣₑₛₕ) that follows time t₀ may then be used to determine whether a second tap occurs. In some examples, the duration (length) of the time window 624 may be specific to single tap detection. In other examples, the duration of the time window 624 may be associated with all gestures that may be detected. For example, the time window 624 for single taps may the same as the time window 606 for double taps, but may be different for different gesture detections.

Next, and during the time window 624, a break peak 632 may occur. However, because the break peak 632 does not exceed the threshold value 622, the break peak 632 does not trigger the detection of a second tap. Once the time window 624 ends without a second make peak being detected, the gesture detection process may conclude that a single tap (and not a double tap) has occurred, and detect a single tap gesture.

Waveforms similar to those shown in FIGS. 6A and 6B may result from other gestures to be detected, such as a tap and hold, a tap and ramp, a tap and slide, a finger segmentation, a hover, a point, or a surface tap.

For a tap and hold, or a tap and ramp, exceeding a threshold value for the rate of change may indicate the initial contact between two digits (the tap), and a lack of a break peak may be used to detect that the two digits maintain contact (the hold, or the ramp), for example to differentiate the tap and hold from a single tap. In other examples, exceeding a threshold value for the rate of change may indicate the initial contact between two digits (the tap), and other information from the FMCW sensor, such as the range value, may be used to confirm the gesture, or distinguish between gestures (e.g., between a tap and hold and a tap and ramp).

In some examples, gesture detection may commence or a gesture detection mode started, based on detecting a trigger event (e.g., the occurrence of a gating event). For example, a gesture detection mode may commence with the detection of a phone call or receipt of a notification. An FMCW sensor of the wearable device may then perform one or more measurement in response to entering the gesture detection mode.

In some examples, information from an additional sensor may be used in gesture detection as a confirmatory gesture detection mechanism. For example, a gesture detection may be performed as further described above as a first gesture detection mechanism, while the confirmatory gesture detection mechanism confirms the detected gesture, or may be used to differentiate between two gestures detected using the first detect mechanism that uses the FMCW sensor. For example, for a tap and slide, the primary detection mechanism may detect a make contact, and the secondary detection mechanism may be used to detect the slide between the make contact and break contact detections by the primary detection mechanism.

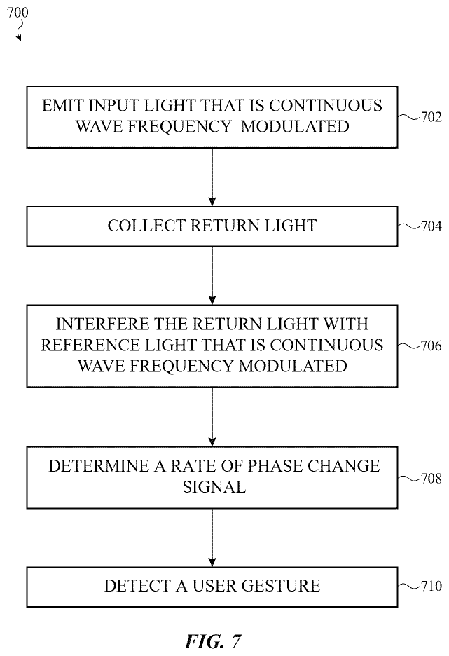

FIG. 7 shows an example method 700 of gesture detection, as described herein. In some cases, one or more aspects of the method 700 may be performed by the wearable device 100, or one or more components thereof, for example an optical sensing assembly (e.g., the optical sensing assembly 140), an FMCW sensor (e.g., the FMCW sensor 150), a processor (e.g., processor 128), or a combination of these. In some embodiments, the processor (e.g., processor 128) may include or be coupled to memory (e.g., memory 130) that may store instructions that, when executed by the processor, cause the processor to perform the operations of the method 700. As the processor performs the operations of the method 700, the processor may also cause the wearable device 100, or one or more components thereof, for example the light source module, to perform or discontinue various operations.

At 702, the method 700 includes emitting input light that is continuous wave frequency modulated. In some embodiments, the method 700 includes emitting, while the wearable device is in contact with a skin surface of a user of the wearable device, input light that is modulated according to a continuous wave frequency modulation.

At 704, the method 700 includes collecting return light. In some embodiments, the method 700 includes collecting return light while the wearable device is in contact with the skin surface.

At 706, the method 700 includes interfering the return light with reference light that is continuous wave frequency modulated. In some embodiments, the method 700 includes obtaining an FMCW interference signal based at least in part on the return light and reference light, the reference light modulated according to the continuous wave frequency modulation.

At 708, the method 700 includes determining rate of phase change signal. In some embodiments, the method 700 includes determining a rate of phase change signal from the FMCW interference signal.

At 710, the method 700 includes detecting a gesture. In some embodiments, the method 700 includes detecting, from the rate of phase change signal, a gesture performed by the user.

In one or more embodiments, the method further includes selecting, from the one or more candidate gestures, a first gesture (e.g., a single tap) as the gesture based at least in part on determining that the rate of phase change does not exceed the threshold value during a second time during a time window following the first time. In one or more embodiments, the method further includes selecting, from the one or more candidate gestures, a second gesture (e.g., a double tap) as the gesture based at least in part on determining that the rate of phase change has exceeded the threshold value at a second time during a time window following the first time. In one or more embodiments, the method further includes selecting, from the one or more candidate gestures, a third gesture (e.g., a tap and hold) as the gesture based at least in part on determining that the rate of phase change has stayed above the threshold value for at least a threshold time duration following the first time.

In one or more embodiments, the method further includes obtaining sensor data from one or more additional sensors of the wearable device, where detecting the gesture is further based at least in part on the sensor data from the one or more additional sensors. In some embodiments, the one or more additional sensors may be an inertial measurement unit. In some embodiments, the inertial measurement unit may include one or more of an accelerometer, a gyroscope, or a magnetometer.

In one or more embodiments, the method further includes detecting a triggering event has occurred at the wearable device; and operating, responsive to detecting that the triggering even has occurred, an FMCW sensor to perform the various operations of method 700.

The method 700 may be variously embodied, extended, or adapted, as described in the following paragraphs and elsewhere in this description.

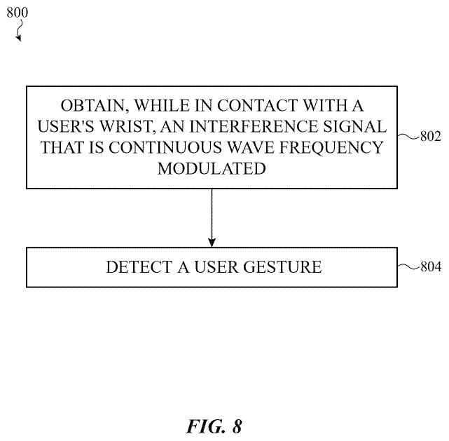

FIG. 8 shows another example method 800 of gesture detection, as described herein. In some cases, one or more aspects of the method 800 may be performed by the wearable device 100, or one or more components thereof, for example an optical sensing assembly (e.g., the optical sensing assembly 140), an FMCW sensor (e.g., the FMCW sensor 150), a processor (e.g., processor 128), or a combination of these. In some embodiments, the processor (e.g., processor 128) may include or be coupled to memory (e.g., memory 130) that may store instructions that, when executed by the processor, cause the processor to perform the operations of the method 800. As the processor performs the operations of the method 800, the processor may also cause the wearable device 100, or one or more components thereof, for example the light source module, to perform or discontinue various operations.

At 802, the method 800 includes obtaining an FMCW interference signal while in contact with a user's wrist. In some embodiments, the method 800 includes obtaining, at a wearable device, an FMCW interference signal that is based at least in part on return light collected while the wearable device is in contact with a wrist of a user.

At 804, the method 800 includes detecting a gesture. In some embodiments, the method 800 includes detecting, based at least in part on the FMCW interference signal, a gesture performed by the user.

In some embodiments, the gesture is selected from a set of candidate gestures including at least a single tap, a double tap, or a tap and hold.

In some embodiments, the wearable device includes an FMCW sensor that includes a first transparent window configured to contact the skin surface of the user, a second transparent window configured to contact the skin surface of the user, a first coupler to direct the input light to be emitted through the first transparent window, and a second coupler to collect the return light through the second transparent window.

In some embodiments, the wearable device includes an FMCW sensor that includes a transparent window to contact the skin surface of the user, a first coupler to direct the input light to be emitted through the transparent window, and a second coupler to collect the return light through the transparent window.

In some embodiments, the wearable device includes one or more additional sensors, and is configured to detect the gesture from the rate of phase change information and sensor data from the one or more additional sensors. In some embodiments, the one or more additional sensors is an inertial measurement unit. In some embodiments, the inertial measurement unit may include one or more of an accelerometer, a gyroscope, or a magnetometer. In some embodiments the one or more additional sensors include an electromyography sensor, a microphone, or a camera.

In some embodiments, the wearable device includes a laser that is modulated to generate laser light according to the continuous wave frequency modulation, and an optical splitter to provide the reference light and the input light to be emitted.

In some embodiments, the wearable device includes a display on a front surface of the wearable device, where the input light is emitted from a back surface of the wearable device.

The method 800 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 700 or 800. This non-transitory computer-readable media may be, for example, a memory of a wearable device (such as a memory 130, as described herein).

Embodiments contemplated herein include an apparatus having logic, modules, or circuitry to perform one or more elements of the method 700 or 800. This apparatus may be, for example, an apparatus of a wearable device (such as a wearable device 100).

Embodiments contemplated herein include an apparatus having one or more processors and one or more computer-readable media, using or storing instructions that, when executed by the one or more processors, cause the one or more processors to perform one or more elements of the method 700 or 800. This apparatus may be, for example, an apparatus of a wearable device (such as a wearable device 100, as described herein).

Embodiments contemplated herein include a computer program or computer program product having instructions, wherein execution of the program by a processor causes the processor to carry out one or more elements of the method 700 or 800. The processor may be a processor of a wearable device 100 (such as a processor(s) 128, as described herein), and the instructions may be, for example, located in the processor and/or on a memory of the wearable device 100 (such as a memory 130, as described herein).

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. A method of gesture detection at a wearable device, comprising:
emitting, while the wearable device is in contact with a skin surface of a user of the wearable device, input light that is modulated according to a continuous wave frequency modulation;
collecting return light while the wearable device is in contact with the skin surface;
obtaining a frequency modulation continuous wave (FMCW) interference signal based at least in part on the return light and reference light, the reference light modulated according to the continuous wave frequency modulation;
determining a rate of phase change signal from the FMCW interference signal; and
detecting, from the rate of phase change signal, a gesture performed by the user.

2. The method of claim 1, wherein determining the rate of phase change signal comprises:
obtaining a plurality of signal segments from the FMCW interference signal corresponding to individual chirps of the continuous wave frequency modulation; and
performing a first Fourier transform operation on each of the signal segments to generate a corresponding frequency spectrum.

3. The method of claim 2, wherein determining the rate of phase change signal comprises:
obtaining one or more channels of complex representations of beat frequencies corresponding to the plurality of signal segments; and
performing a second Fourier transform operation on each of the one or more channels of complex representations of beat frequencies to generate a corresponding plurality of frequency spectra.

4. The method of claim 1, wherein detecting the gesture comprises:
detecting that the rate of change at a first time has exceeded a threshold value associated with one or more candidate gestures of a set of candidate gestures; and
selecting, from the one or more candidate gestures, the gesture performed by the user.

5. The method of claim 4, wherein detecting the gesture further comprises:
selecting, from the one or more candidate gestures, a second gesture as the gesture based at least in part on determining that the rate of change has exceeded the threshold value at a second time during a time window following the first time.

6. The method of claim 4, wherein detecting the gesture further comprises:
selecting, from the one or more candidate gestures, a third gesture as the gesture based at least in part on determining that the rate of change has stayed above the threshold value for at least a threshold time duration following the first time.

7. The method of claim 4, wherein detecting the gesture further comprises:
selecting, from the one or more candidate gestures, a first gesture as the gesture based at least in part on determining that the rate of change does not exceed the threshold value during a second time during a time window following the first time.

8. The method of claim 1, further comprising:
obtaining sensor data from one or more additional sensors of the wearable device, wherein:
detecting the gesture is further based at least in part on the sensor data from the one or more additional sensors.

9. The method of claim 8, wherein:
the one or more additional sensors comprise an inertial measurement unit.

10. The method of claim 1, further comprising:
detecting a trigger event has occurred at the wearable device; and
obtaining the FMCW interference signal responsive to detecting that the trigger event has occurred.

11. A wearable device, comprising:
an optical sensing assembly comprising a frequency modulation continuous wave (FMCW) sensor, the optical sensing assembly configured to:
generate reference light that is modulated according to a continuous wave frequency modulation;
emit input light that is modulated according to the continuous wave frequency modulation;
collect return light; and
a band configured to, while emitting the input light and collecting the return light, maintain the FMCW sensor in contact with a skin surface of a user of the wearable device; and
one or more processors configured to:
obtain an FMCW interference signal based at least in part on the return light and the reference light;
determine a rate of phase change signal from the FMCW interference signal; and
detect, from the rate of phase change signal, a gesture performed by the user.

12. The wearable device of claim 11, wherein the FMCW sensor of the optical sensing assembly further comprises:
a first transparent window configured to contact the skin surface of the user;
a second transparent window configured to contact the skin surface of the user;
a first coupler to direct the input light to be emitted through the first transparent window; and
a second coupler to collect the return light through the second transparent window.

13. The wearable device of claim 11, wherein the FMCW sensor of the optical sensing assembly further comprises:
a transparent window to contact the skin surface of the user;
a first coupler to direct the input light to be emitted through the transparent window; and
a second coupler to collect the return light through the transparent window.

14. The wearable device of claim 11, further comprising:
one or more additional sensors, wherein the one or more processors are configured to detect the gesture from the rate of phase change signal and sensor data from the one or more additional sensors.

15. The wearable device of claim 14, wherein:
the one or more additional sensors comprise an inertial measurement unit.

16. The wearable device of claim 11, wherein the optical sensing assembly further comprises:
a laser that is modulated to generate laser light according to the continuous wave frequency modulation; and
an optical splitter to provide the reference light and the input light to be emitted.

17. The wearable device of claim 11, further comprising:
a display on a front surface of the wearable device, wherein:
the input light is emitted from a back surface of the wearable device.

18. A method of gesture detection, comprising:
obtaining, at a wearable device, a frequency modulation continuous wave (FMCW) interference signal that is based at least in part on return light collected while the wearable device is in contact with a wrist of a user; and
detecting, based at least in part on the FMCW interference signal, a gesture performed by the user.

19. The method of claim 18, wherein:
the gesture is selected from a set of candidate gestures comprising at least a single tap, a double tap, or a tap and hold.

20. The method of claim 18, comprising:
generating, using the FMCW interference signal, a rate of phase change signal.
